(19) United States
(12) Patent Application Publication
(10) Pub. No.: US 2018/0371316 A1
(43) Pub. Date: Dec. 27, 2018

(54) A GROUND COVER MULCH IMPREGNATED WITH SUPERCRITICAL FLUID COMPRISING A COLORANT

(71) Applicant: STORA ENSO OYJ, Helsinki (FI)

(72) Inventors: Kaj Backfolk, Lappeenranta (FI); Risto Kallio, Lappeenranta (FI); Carl-Mikael Tag, Tuusula (FI)

(21) Appl. No.: 15/779,179

(22) PCT Filed: Nov. 25, 2016
(86) PCT No.: PCT/IB2016/057128

§ 371 Date: May 25, 2018

(30) Foreign Application Priority Data
Nov. 27, 2015 (SE) 1551545-5

(51) Int. Cl. C09K 17/52; D21H 21/16; D21H 21/20; D21H 21/28; D21H 21/36; D21H 17/67; D21H 17/00; D21H 17/60; D21H 17/01; D21H 19/38; C05G 3/00; A01G 13/02

(52) U.S. Cl. CPC C09K 17/52; D21H 21/16; D21H 21/20; D21H 21/285; D21H 21/36; D21H 17/67; A01G 13/0275; D21H 17/60; D21H 17/01; D21H 19/38; C05G 3/0047; A01G 13/0262; D21H 17/005

(57) ABSTRACT

A ground cover in the form of a mulch, allowing air and moist to permeate, which includes a paper substrate originating from fibre-bearing pulp, preferably emanating from lignocellulosic material, which has been web-formed or sheet-formed, characterized in that the substrate has been impregnated with supercritical fluid, preferably CO2, alternatively a fluid under high pressure such as near supercritical conditions, wherein also one or more colorant(s) is (are) present in said fluid. Also a method for its manufacture and use thereof are disclosed.

### FIELD OF INVENTION

The present invention relates to a ground cover, preferably in the form of a mulch, which substrate have been impregnated with supercritical fluid or similar, wherein also one or more colorant(s) is (are) present in the supercritical fluid. Also methods for its manufacture and use thereof are disclosed. The cover is further compostable and biodegradable. Said cover also has an improved permeability.

### BACKGROUND

A common solution today is to use plastic based films before planting the seeds. This plastic film prevent weed from growing, reduces amount of needed pesticides, fungicides or herbicides, enhances temperature of the soil, and control moisture content of soil. The use of mulches in agriculture is as said dominated by various plastic films and composites. The use of such a film also protects the crop from weed infestation, weed growth, and insects etc. Most of the plastic developed for this purpose are not sustainable or made from sustainable materials although being biodegradable. The use of a paper based material, on the other hand, is environmental concept but too usually too porous to improve the fumigation process.

One of the problems with plastic is that the farmers do not collect the plastic film back after harvesting the crop. This is one reason why biodegradable and sustainable solutions need to be implemented. Changes in EU legislation seem also to favor biodegradable alternatives in the near future. Currently, as said, various types of plastic are used as mulches. Paper has also been considered too expensive and to degrade too fast.

Another problem lies in its complicated process, which usually involves a surface treatment or a coating step. This coating targets to color the paper black, on one or both sides, and or to include other surface active agents such as water repellant chemicals, optical-, strength- or bioactive agents.

Also there is a problem with the coating of a paper-based mulch, as the use of additive such as carbon black requires binders. These binders will in change the permeability of the paper and hence a dense substrate is obtained. When laid on the soil, water will condense on the backside which hence favors the microbial activity.

Another problem is that coating is usually limited to impact coating methods, which also means that the impact might reduce paper strength properties. Another problem is that impact or non-impact coating methods, will both be causing obvious z-profile and hence e.g. optical properties also will be suffering. The use of impact coating or surface treatment methods are also sensitive to the properties of the base paper and require that the coating holdout is good in order not to cause runnability problems on the coating machine. For example, if the substrate is very permeable or contains holes, the coating liquid will penetrate through the paper and might hence cause web breaks etc. due to formation of deposits on the rolls. There is thus a need to solve one or more of the above problems and still maintain the important physical criteria needed for paper-based covers, preferably mulches, such as high strength, elasticity, controlled microbial degradability and cost efficient product. Also there is a need for a ground cover, preferably in the form of a mulch, that allows air and moist to permeate.

The present invention addresses the problems of paper based mulches that are not too permeable when it comes to air and moist. At the same time, the ground cover, preferably in the form of a mulch, should be eco-friendly and have certain physical properties and be durable against water and wind. There is thus a need for an improved ground cover, preferably in the form of a mulch.

It has now surprisingly been found, that a ground cover, preferably in the form of a paper mulch, that solves one or more of the above problems can be made by using a supercritical fluid, preferably CO₂ impregnation step. Using supercritical fluids has been disclosed in “Polymer Processing with supercritical fluids”, S. G. Kazarian, Polymer Science, Ser. C, Vol 42, No 1, 2000, pp-101. By dissolving a dye in the fluid, preferably CO₂, it is possible to impregnate the cover, preferably in the form of a paper mulch, with substantially no binder in use. In this way, it is possible to maintain a more open structure of the web and hence ensure that WVTR (Water Vapor Transmission Rate) is sufficient. At the same time the degradation of the cover is likely to be slower as too high water vapor barrier properties may cause too fast degradation of a bio-based ground cover (such as a paper mulch). The solution further simplifies the manufacturing process (costs) of making a ground cover material, such as in the form of a mulch.

### SUMMARY OF INVENTION

The present invention thus solves one or more of the above problems, by providing according to a first aspect a ground cover in the form of a mulch, allowing air and moist to permeate, which includes a paper substrate originating from fibre-bearing pulp, preferably emanating from lignocellulosic material, which has been web-formed or sheet-formed, characterized in that the substrate has been impregnated with a supercritical fluid, preferably CO₂, alternatively a fluid, wherein said fluid may also preferably be CO₂, under high pressure such as near-supercritical conditions, wherein also one or more colorant(s) is (are) present in said fluid. This cover may also comprise a laminated structure or be part of a laminated structure.

Also provided according to a second aspect of the invention is a method for manufacturing a ground cover in the form of a mulch, according to the first aspect of the present invention comprising the following steps:
a) providing a fiber suspension, preferably emanating from lignocellulosic material,
b) optionally adding also one or more filler(s), to the fibres, and
c) forming a paper/board web substrate or sheet, preferably involving also drying, and
d) impregnating said web substrate or sheet with a supercritical fluid, preferably CO₂, alternatively a fluid, wherein said fluid may also preferably be CO₂, under high pressure such as near-supercritical conditions, comprising one or more colorants, also optionally comprising one or more hydrophobic agents, such as one or more waxes, additionally optionally one or more bioactive chemical(s), thus providing a cover.

Also provided according to a third aspect of the invention is a ground cover in the form of a mulch, obtainable by a method according to the second aspect.

Also provided according to a fourth aspect of the invention is use of a ground cover in the form of a mulch, according to the first and third aspect, in cultivation. This embraces also the use in farming and horticulture. The paper web substrate may also be a multi-ply paper.

### DETAILED DESCRIPTION OF THE INVENTION

It is intended throughout the present description that the expression “colorant” embraces any type of colorant that maybe useful in the context of ground covers, such as mulches.

The expressions “fibre” and “fiber” are further used interchangeably in the present description meaning the same thing.

Most preferably the colorants are derived from biological/nature sources and are allowed for direct food contact.

The pulp mentioned in the present description, may be chemical pulp, mechanical pulp, thermomechanical pulp or, chemi(thermo)mechanical pulp (CMP or CTMP). Said chemical pulp may be a mechanical pulp, sulphite pulp or a Kraft pulp, preferably a mechanical pulp.

The pulp may consist of pulp from hardwood, softwood or both types. The pulp may e.g. contain a mixture of pine and spruce or a mixture of birch and spruce. The pulp may also comprise recycled paper or paperboard. The chemical pulps that may be used in the present invention include all types of chemical wood-based pulps, such as bleached, half-bleached and unbleached sulphite, Kraft and soda pulps, and mixtures of these. The pulp may be of dissolved type. The pulp may also comprise textile fibers. The pulp may also come from agriculture (e.g. potato, bamboo or carrot). The pulp may also be so-called nanopulp or highly fibrillated pulp (MFC). Said nanopulp or highly fibrillated pulp (MFC) may also be chemically modified. Also combinations of said pulp types are possible in the context of the present invention. The pulp may also contain synthetic fibers or biofibers such as PLA (Poly-lactic acid).

According to a further preferred embodiment of the first aspect of the invention the additionally one or more hydrophobic agents, such as waxes, is (are) present in the supercritical fluid, which is preferably CO2. Said waxes aim to prevent fiber-fiber bonds (hydrogen bonds) but will still allow air and moist to permeate through the cover. Said waxes may also be wet strength chemicals in wax form, such as AKD. Said waxes may also include beeswaxes.

According to a further preferred embodiment of the first aspect of the invention the cover additionally comprises one or more wet strength agent(s).

Wet strength chemicals may be e.g. UF resins (urea-formaldehyde), melamine-formaldehyde resins (MF), polyamide-amine epichlorohydrine (PARE), Epichlorohydrine (ECH), polyacryl amide/glyoxal, starch/glyoxal
Water soluble polymers such as fixing agents (PDADMAC, CPAM, PEI, PVAm, cationic starch), retention chemicals (Cationic PAM, PAM, Anionic PAM, PEI, cationic starch, amphoteric starch, PEO, etc.), dry (cationic starch, different gums, acrylamide based polymers (PAM), polyvinyl amine (PVAm), CMC, chitosan, etc.) and wet strength agents (see above).
Sizing dispersions such as alkyl ketene dimer (AKD), alkenyl succinic anhydride (ASA), rosins.

According to a further preferred embodiment of the first aspect of the invention said cover comprises additionally one or more fillers selected from the group comprising ground or precipitated calcium carbonate, talc, kaolin, silica, fly ash, lime, CaO or CaOH₂, chalk (CaCO₃), quartz and aluminium oxides or combinations thereof. These fillers may also re-cycled. Some of these fillers may also act as pH control agents.

According to a further preferred embodiment of the first aspect of the invention the colorant(s) is a black filler, preferably carbon black. The carbon black may preferably emanate from lignin.

According to a further preferred embodiment of the first aspect of the invention the colorant(s) include(s) one or more UV absorbents.

According to a further preferred embodiment of the first aspect of the invention said cover comprises also one or more bioactive chemical(s), pH control agent(s), optically active agents and/or nutrient(s) or combinations thereof. The biocides may be a fungicide or a bactericide or a combination thereof. The nutrient(s) or optical active agents may also be stimulants for photosynthesis. These said components may be co-mixed with the colorants(s).

According to a further preferred embodiment of the first aspect of the invention the bioactive chemical(s) are selected from enzymes, biocides and pesticides and combinations thereof. These said components may also be co-mixed with the colorants(s).

According to a further preferred embodiment of the first aspect of the invention the carbon black emanates from a non-fossil source, preferably from biomass or organic waste residues of non-fossil origin, such as from lignin.

According to a further preferred embodiment of the method according to the second aspect of the present invention the forming is made with a dry or wet laid process, preferably a wet laid process. The wet laid process may be, for example, a traditional papermaking concept based on a Fourdrinier machine. The papermaking may further comprise a single or multilayer wet web forming technique.

According to a further preferred embodiment of the method according to the second aspect of the present invention steps b), c), and, optionally d), are performed at the wet end of a paper/board production line.

According to a further preferred embodiment of the method according to the second aspect of the present invention step b) also comprises adding one or more bioactive chemical(s), pH control agent(s) and/or nutrient(s) or combinations thereof.

At the same time the ground cover, preferably in the form of a mulch, according to the first aspect of the present invention provides a relatively open structure. Said ground cover, such as a mulch, according to the present invention also provides strength improvements and elasticity. The method for manufacturing the ground cover, preferably a mulch, according to the first aspect may also include one or more additional surface treatment steps.

Preferred features of each aspect of the invention are as for each of the other aspects mutatis mutandis. Any prior art documents mentioned herein are incorporated to the fullest extent permitted by law.

In view of the above detailed description of the present invention, other modifications and variations will become apparent to those skilled in the art. However, it should be apparent that such other modifications and variations may be effected without departing from the spirit and scope of the invention.

1. A ground cover in the form of a mulch, allowing air and moisture to permeate, comprising a paper substrate originating from fibre-bearing pulp, which has been web-formed or sheet-formed, wherein the substrate has been impregnated with supercritical fluid, wherein at least one colorant is present in said supercritical fluid.

2. The cover according to claim 1 wherein additionally at least one hydrophobic agent, is present in the supercritical fluid.

3. The cover according to claim 1 further comprising at least one wet strength agent.

4. The cover according to claim 1 further comprising at least one filler selected from the group consisting of ground or precipitated calcium carbonate, talc, kaolin, silica, fly ash, lime, CaO or CaOH₂, chalk (CaCO₃), quartz and aluminium oxides and combinations thereof.

5. The cover according to claim 1 wherein the colorant is a black filler.

6. The cover according to claim 1 wherein the colorant includes at least one UV absorbent.

7. The cover according to claim 1 further comprising at least one bioactive chemical, pH control agent and/or nutrient or combinations thereof.

8. The cover according to claim 7 wherein the bioactive chemical is selected from enzymes, biocides and pesticides and combinations thereof.

9. The cover according to claim 5 wherein the black filler emanates from a non-fossil source.

10. A method for manufacturing a ground cover in the form of a mulch, according to claim 1 comprising the following steps:
a) providing a fiber suspension,
b) forming a paper/board web substrate or sheet, and
c) impregnating said web substrate or sheet with a supercritical fluid, comprising one or more colorants, thus providing a cover.

11. The method for manufacturing a cover according to claim 10 wherein the forming, is made with a dry or wet laid process.

12. The method for manufacturing a cover according to claim 10 wherein step b) is performed at the wet end of a paper/board production line

13. The method for manufacturing a cover according to claim 10 further comprising after step a) adding at least one filler to the fibres, and adding one or more bioactive chemical(s), pH control agent(s), optically active agents and/or nutrient(s) or combinations thereof.

14. A ground cover in the form of a mulch, obtainable by a method as set out in claim 10.

15. (canceled)

16. The cover according to claim 1 wherein the supercritical fluid is CO₂.

17. The cover according to claim 1 wherein the supercritical fluid is a fluid under high pressure.

18. The cover according to claim 1 wherein the fibre-bearing pulp emanates from lignocellulosic material.

19. The cover according to claim 2 wherein the hydrophobic agent is a wax.

20. The cover according to claim 1 wherein the colorant is carbon black.

21. The cover according to claim 5 wherein the black filler emanates from biomass or organic waste residues of non-fossil origin.

22. The method of claim 10 wherein the fiber suspension emanates from lignocellulosic material.

23. The method of claim 10 further comprising a step of adding at least one filler to the fibres after step a).

24. The method of claim 10 further comprising drying the paper/board web substrate or sheet.

25. The method of claim 10 wherein the supercritical fluid is CO₂.

26. The method of claim 10 wherein the supercritical fluid is a fluid under high pressure.

27. The method of claim 10 wherein the supercritical fluid further comprises one or more hydrophobic agents.

28. The method of claim 10 wherein the supercritical fluid further comprises at least one wax.

29. The method of claim 10 wherein the supercritical fluid further comprises at least one bioactive chemical.
